(19) United States
(12) Patent Application Publication
(10) Pub. No.: US 2026/0164449 A1
(43) Pub. Date: Jun. 11, 2026

(54) TECHNIQUES FOR ADAPTATION OF DOWNLINK CONTROL PARAMETERS

(71) Applicant: QUALCOMM Incorporated, San Diego, CA (US)

(72) Inventors: Mahmoud TAHERZADEH BOROUJENI, San Diego, CA (US); Pinar SEN, San Diego, CA (US); Wei YANG, San Diego, CA (US); Tao LUO, San Diego, CA (US)

(21) Appl. No.: 18/974,480

(22) Filed: Dec. 9, 2024

(51) Int. Cl. H04W 72/232; H04L 5/00; H04W 72/1273

(52) U.S. Cl. CPC H04W 72/232; H04L 5/0051; H04W 72/1273

(57) ABSTRACT

Methods, systems, and devices for wireless communications are described. A user equipment may transmit a request for a downlink control parameter associated with a control channel. The downlink control parameter may indicate one or more of: a precoder cycling or a demodulation reference signal bundling. The UE may receive, based at least in part on the request, a downlink control message in accordance with the downlink control parameter.

### TECHNICAL FIELD

The following relates to wireless communications, including techniques for adaptation of downlink control parameters.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting a request for a downlink control parameter associated with a control channel, where the downlink control parameter indicates one or more of: a precoder cycling or a demodulation reference signal (DMRS) bundling and receiving, based on the request, a downlink control message in accordance with the downlink control parameter.

A UE for wireless communications is described. The UE may include one or more memories storing processor executable code, and one or more processors coupled with the one or more memories. The one or more processors may individually or collectively be operable to execute the code to cause the UE to transmit a request for a downlink control parameter associated with a control channel, where the downlink control parameter indicates one or more of: a precoder cycling or a DMRS bundling and receive, based on the request, a downlink control message in accordance with the downlink control parameter.

Another UE for wireless communications is described. The UE may include means for transmitting a request for a downlink control parameter associated with a control channel, where the downlink control parameter indicates one or more of: a precoder cycling or a DMRS bundling and means for receiving, based on the request, a downlink control message in accordance with the downlink control parameter.

A non-transitory computer-readable medium storing code for wireless communications is described. The code may include instructions executable by one or more processors to transmit a request for a downlink control parameter associated with a control channel, where the downlink control parameter indicates one or more of: a precoder cycling or a DMRS bundling and receive, based on the request, a downlink control message in accordance with the downlink control parameter.

In some examples of the method, user equipment (UEs), and non-transitory computer-readable medium described herein, transmitting the request may include operations, features, means, or instructions for transmitting a control signal indicating the request, where the control signal indicates one or more of: a medium access control-control element (MAC-CE) or an uplink control channel message.

In some examples of the method, user equipment (UEs), and non-transitory computer-readable medium described herein, transmitting the request may include operations, features, means, or instructions for transmitting a scheduling request, where the scheduling request includes the request for the downlink control parameter.

Some examples of the method, user equipment (UEs), and non-transitory computer-readable medium described herein may further include operations, features, means, or instructions for receiving, based on the request, a confirmation associated with the request.

In some examples of the method, user equipment (UEs), and non-transitory computer-readable medium described herein, the downlink control parameter associated with the request may be valid for a defined time duration.

In some examples of the method, user equipment (UEs), and non-transitory computer-readable medium described herein, the downlink control parameter associated with the request may be valid until an indication of a change to the downlink control parameter may be received.

In some examples of the method, user equipment (UEs), and non-transitory computer-readable medium described herein, transmitting the request may include operations, features, means, or instructions for transmitting the request based on a channel signal-to-noise ratio (SNR) estimate satisfying a defined threshold.

Some examples of the method, user equipment (UEs), and non-transitory computer-readable medium described herein may further include operations, features, means, or instructions for receiving control signaling that indicates the defined threshold.

In some examples of the method, user equipment (UEs), and non-transitory computer-readable medium described herein, transmitting the request may include operations, features, means, or instructions for transmitting the request for the precoder cycling and receiving, based on the request, control signaling indicating a configuration associated with a unitary rotation for the downlink control message, the configuration indicating one or more resources of the control channel associated with the downlink control message.

In some examples of the method, user equipment (UEs), and non-transitory computer-readable medium described herein, the unitary rotation includes a two-symbol unitary rotation.

In some examples of the method, user equipment (UEs), and non-transitory computer-readable medium described herein, the two-symbol unitary rotation may be applied to at least a quadrature phase shift keying (QPSK) symbol associated with the control channel.

A method for wireless communications by a UE is described. The method may include receiving first control signaling indicating a first configuration associated with a unitary rotation for a first downlink control message, the first configuration indicating one or more first resources of a control channel associated with the first downlink control message, where the first configuration indicates a precoder cycling and receiving the first downlink control message via the one or more first resources of the control channel, the first downlink control message having the unitary rotation applied in accordance with the first configuration.

A UE for wireless communications is described. The UE may include one or more memories storing processor executable code, and one or more processors coupled with the one or more memories. The one or more processors may individually or collectively be operable to execute the code to cause the UE to receive first control signaling indicating a first configuration associated with a unitary rotation for a first downlink control message, the first configuration indicating one or more first resources of a control channel associated with the first downlink control message, where the first configuration indicates a precoder cycling and receive the first downlink control message via the one or more first resources of the control channel, the first downlink control message having the unitary rotation applied in accordance with the first configuration.

Another UE for wireless communications is described. The UE may include means for receiving first control signaling indicating a first configuration associated with a unitary rotation for a first downlink control message, the first configuration indicating one or more first resources of a control channel associated with the first downlink control message, where the first configuration indicates a precoder cycling and means for receiving the first downlink control message via the one or more first resources of the control channel, the first downlink control message having the unitary rotation applied in accordance with the first configuration.

A non-transitory computer-readable medium storing code for wireless communications is described. The code may include instructions executable by one or more processors to receive first control signaling indicating a first configuration associated with a unitary rotation for a first downlink control message, the first configuration indicating one or more first resources of a control channel associated with the first downlink control message, where the first configuration indicates a precoder cycling and receive the first downlink control message via the one or more first resources of the control channel, the first downlink control message having the unitary rotation applied in accordance with the first configuration.

In some examples of the method, user equipment (UEs), and non-transitory computer-readable medium described herein, the unitary rotation includes a two-symbol unitary rotation.

In some examples of the method, user equipment (UEs), and non-transitory computer-readable medium described herein, the two-symbol unitary rotation may be applied to at least a QPSK symbol associated with the control channel.

In some examples of the method, user equipment (UEs), and non-transitory computer-readable medium described herein, the first configuration indicates an absence of DMRS bundling.

In some examples of the method, user equipment (UEs), and non-transitory computer-readable medium described herein, the first configuration indicates a distributed mapping of resource element group (REG) bundles to control channel elements (CCEs) or a non-distributed mapping may be distributed or non-distributed mapping of REG bundles to CCEs.

Some examples of the method, user equipment (UEs), and non-transitory computer-readable medium described herein may further include operations, features, means, or instructions for transmitting a request for a DMRS bundling and receiving, based on the request, a confirmation associated with the request.

Some examples of the method, user equipment (UEs), and non-transitory computer-readable medium described herein may further include operations, features, means, or instructions for transmitting, subsequent to the first control signaling, a request for a DMRS bundling and receiving, based on the request, a second downlink control message in accordance with the request, where the second downlink control message may be exempt from the unitary rotation in accordance with the first configuration.

Some examples of the method, user equipment (UEs), and non-transitory computer-readable medium described herein may further include operations, features, means, or instructions for receiving second control signaling indicating a second configuration unassociated with the unitary rotation, the second configuration indicating one or more second resources of the control channel associated with a second downlink control message and receiving the second downlink control message via the one or more second resources of the control channel, the second downlink control message in accordance with the second configuration.

A method for wireless communications by a network entity is described. The method may include obtaining a request for a downlink control parameter associated with a control channel, where the downlink control parameter indicates one or more of: a precoder cycling or a DMRS bundling and outputting, based on the request, a downlink control message in accordance with the downlink control parameter.

A network entity for wireless communications is described. The network entity may include one or more memories storing processor executable code, and one or more processors coupled with the one or more memories. The one or more processors may individually or collectively be operable to execute the code to cause the network entity to obtain a request for a downlink control parameter associated with a control channel, where the downlink control parameter indicates one or more of: a precoder cycling or a DMRS bundling and output, based on the request, a downlink control message in accordance with the downlink control parameter.

Another network entity for wireless communications is described. The network entity may include means for obtaining a request for a downlink control parameter associated with a control channel, where the downlink control parameter indicates one or more of: a precoder cycling or a DMRS bundling and means for outputting, based on the request, a downlink control message in accordance with the downlink control parameter.

A non-transitory computer-readable medium storing code for wireless communications is described. The code may include instructions executable by one or more processors to obtain a request for a downlink control parameter associated with a control channel, where the downlink control parameter indicates one or more of: a precoder cycling or a DMRS bundling and output, based on the request, a downlink control message in accordance with the downlink control parameter.

Some examples of the method, network entities, and non-transitory computer-readable medium described herein may further include operations, features, means, or instructions for outputting, based on the request, a confirmation associated with the request.

In some examples of the method, network entities, and non-transitory computer-readable medium described herein, obtaining the request may include operations, features, means, or instructions for obtaining the request based on a channel SNR estimate satisfying a defined threshold.

Some examples of the method, network entities, and non-transitory computer-readable medium described herein may further include operations, features, means, or instructions for outputting control signaling that indicates the defined threshold.

In some examples of the method, network entities, and non-transitory computer-readable medium described herein, obtaining the request may include operations, features, means, or instructions for obtaining the request for the precoder cycling and outputting, based on the request, control signaling indicating a configuration associated with a unitary rotation for the downlink control message, the configuration indicating one or more resources of the control channel associated with the downlink control message.

A method for wireless communications by a network entity is described. The method may include outputting first control signaling indicating a first configuration associated with a unitary rotation for a first downlink control message, the first configuration indicating one or more first resources of a control channel associated with the first downlink control message, where the first configuration indicates a precoder cycling and outputting the first downlink control message via the one or more first resources of the control channel, the first downlink control message having the unitary rotation applied in accordance with the first configuration.

A network entity for wireless communications is described. The network entity may include one or more memories storing processor executable code, and one or more processors coupled with the one or more memories. The one or more processors may individually or collectively be operable to execute the code to cause the network entity to output first control signaling indicating a first configuration associated with a unitary rotation for a first downlink control message, the first configuration indicating one or more first resources of a control channel associated with the first downlink control message, where the first configuration indicates a precoder cycling and output the first downlink control message via the one or more first resources of the control channel, the first downlink control message having the unitary rotation applied in accordance with the first configuration.

Another network entity for wireless communications is described. The network entity may include means for outputting first control signaling indicating a first configuration associated with a unitary rotation for a first downlink control message, the first configuration indicating one or more first resources of a control channel associated with the first downlink control message, where the first configuration indicates a precoder cycling and means for outputting the first downlink control message via the one or more first resources of the control channel, the first downlink control message having the unitary rotation applied in accordance with the first configuration.

A non-transitory computer-readable medium storing code for wireless communications is described. The code may include instructions executable by one or more processors to output first control signaling indicating a first configuration associated with a unitary rotation for a first downlink control message, the first configuration indicating one or more first resources of a control channel associated with the first downlink control message, where the first configuration indicates a precoder cycling and output the first downlink control message via the one or more first resources of the control channel, the first downlink control message having the unitary rotation applied in accordance with the first configuration.

In some examples of the method, network entities, and non-transitory computer-readable medium described herein, the unitary rotation includes a two-symbol unitary rotation.

In some examples of the method, network entities, and non-transitory computer-readable medium described herein, the two-symbol unitary rotation may be applied to at least a QPSK symbol associated with the control channel.

Some examples of the method, network entities, and non-transitory computer-readable medium described herein may further include operations, features, means, or instructions for obtaining a request for a DMRS bundling and outputting, based on the request, a confirmation associated with the request.

Some examples of the method, network entities, and non-transitory computer-readable medium described herein may further include operations, features, means, or instructions for obtaining, subsequent to the first control signaling, a request for a DMRS bundling and outputting, based on the request, a second downlink control message in accordance with the request, where the second downlink control message may be exempt from the unitary rotation in accordance with the first configuration.

Some examples of the method, network entities, and non-transitory computer-readable medium described herein may further include operations, features, means, or instructions for outputting second control signaling indicating a second configuration unassociated with the unitary rotation, the second configuration indicating one or more second resources of the control channel associated with a second downlink control message and outputting the second downlink control message via the one or more second resources of the control channel, the second downlink control message in accordance with the second configuration.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for adaptation of downlink control parameters in accordance with one or more aspects of the present disclosure.

FIG. 2 shows an example of a wireless communications system that supports techniques for adaptation of downlink control parameters in accordance with one or more aspects of the present disclosure.

FIG. 3 shows an example of a constellation diagram that supports techniques for adaptation of downlink control parameters in accordance with one or more aspects of the present disclosure.

FIG. 4 shows an example of a process flow that supports techniques for adaptation of downlink control parameters in accordance with one or more aspects of the present disclosure.

FIG. 5 shows an example of a process flow that supports techniques for adaptation of downlink control parameters in accordance with one or more aspects of the present disclosure.

FIGS. 6 and 7 show block diagrams of devices that support techniques for adaptation of downlink control parameters in accordance with one or more aspects of the present disclosure.

FIG. 8 shows a block diagram of a communications manager that supports techniques for adaptation of downlink control parameters in accordance with one or more aspects of the present disclosure.

FIG. 9 shows a diagram of a system including a device that supports techniques for adaptation of downlink control parameters in accordance with one or more aspects of the present disclosure.

FIGS. 10 and 11 show block diagrams of devices that support techniques for adaptation of downlink control parameters in accordance with one or more aspects of the present disclosure.

FIG. 12 shows a block diagram of a communications manager that supports techniques for adaptation of downlink control parameters in accordance with one or more aspects of the present disclosure.

FIG. 13 shows a diagram of a system including a device that supports techniques for adaptation of downlink control parameters in accordance with one or more aspects of the present disclosure.

FIGS. 14 through 17 show flowcharts illustrating methods that support techniques for adaptation of downlink control parameters in accordance with one or more aspects of the present disclosure.

### DETAILED DESCRIPTION

In some cases, wireless communications systems may implement techniques for introducing frequency diversity for control signaling. For example, a network entity or a user equipment (UE) may transmit duplicate signaling using different frequencies to improve a channel estimation performance of a physical downlink control channel (PDCCH). In some examples, the network entity may implement demodulation reference signal (DMRS) bundling across resource element group (REG) bundles to improve the quality for channel estimation of PDCCH. In some cases, a communication channel may be frequency selective where different frequencies within a transmission band may experience varying signal quality, and the DRMS bundling across REG bundles may capture the frequency selectivity of the channel for transmission or reception of the PDCCH. In some cases, precoder cycling among REG bundles may reduce the negative effects of the frequency selective channel. Whether to implement downlink control parameters of DRMS bundling across REG bundles or precoder cycling among REG bundles may depend on conditions at the UE. For example, the conditions may be the quality of channel estimation by the UE and a channel correlation of a transmission antenna port when a signal is received by the UE which may depend on the UE location. Currently, there is no mechanism for the network entity to adapt downlink control parameters related to DRMR bundling and precoder cycling to the UE situation that may change over time.

In accordance with examples as described herein, a wireless communications system may implement techniques for adaptation of downlink control parameters. In some examples, the UE may request switching between the downlink control parameters of a precoder cycling and a DMRS bundling for PDCCH. The DMRS bundling may be across REG bundles or inter-control channel element (CCE) bundles for PDCCH. For example, the UE may transmit, to the network entity, a request for a downlink control parameter associated with a control channel. The downlink control parameter may be a precoder cycling or a DMRS bundling. The UE may receive, based on the request, a downlink control message in accordance with the downlink control parameter. In some cases, the request may be transmitted via a physical uplink control channel or a medium access control-control element (MAC-CE). The request may be transmitted as part of a scheduling request. The request may be activated after confirmation from the network entity or the request may be activated automatically after a processing time. The activated change of switching between precoder cycling and DMRS bundling may be valid for a time duration or may be valid until another indication changes between the precoder cycling and DMRS bundling. In some cases, the UE may receive control signaling indicating a configuration associated with a unitary rotation for a downlink control message. The configuration may indicate one or more resources of a control channel associated with the downlink control message. The configuration may indicate a precoder cycling. The UE may receive the downlink control message via the one or more resources of the control channel, and the downlink control message may have the unitary rotation applied in accordance with the configuration.

Aspects of the disclosure are initially described in the context of wireless communications systems. Aspects of the disclosure are further illustrated by and described with reference to a constellation diagram, process flows, apparatus diagrams, system diagrams, and flowcharts that relate to techniques for adaptation of downlink control parameters.

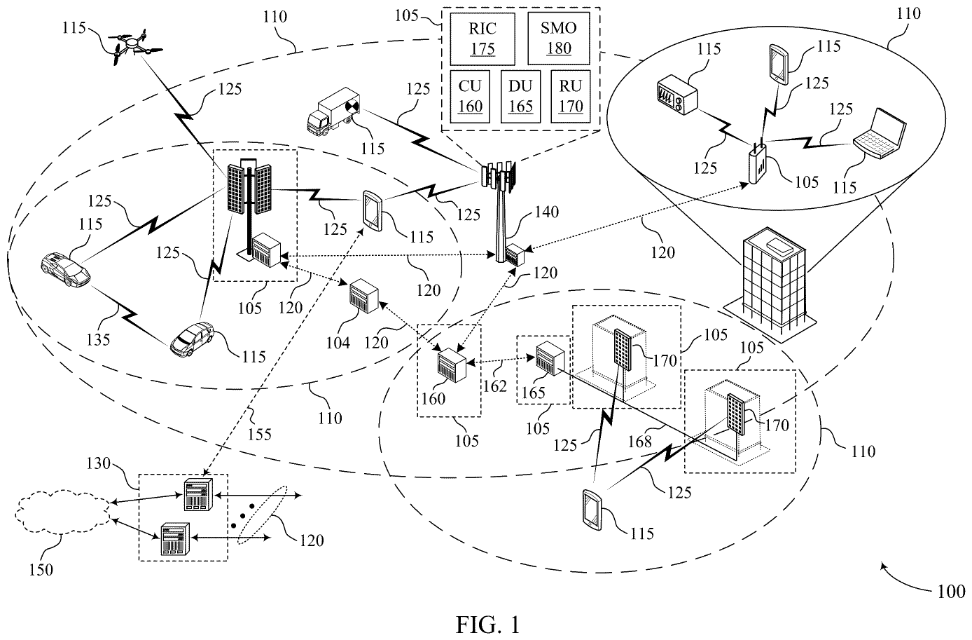

FIG. 1 shows an example of a wireless communications system 100 that supports techniques for adaptation of downlink control parameters in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support techniques for adaptation of downlink control parameters as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a personal computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, the wireless communications system 100 may implement techniques for introducing frequency diversity for control signaling. For example, the network entity 105 or the UE 115 may transmit duplicate signaling using different frequencies to improve a channel estimation performance of a PDCCH. In some examples, the network entity 105 may implement DMRS bundling across REG bundles to improve the quality for channel estimation of PDCCH. In some cases, a communication channel may be frequency selective where different frequencies within a transmission band may experience varying signal quality, and the DRMS bundling across REG bundles may capture the frequency selectivity of the channel for transmission or reception of the PDCCH. In some cases, precoder cycling among REG bundles may reduce the negative effects of the frequency selective channel. Whether to implement downlink control parameters of DRMS bundling across REG bundles or precoder cycling among REG bundles may depend based on conditions at the UE 115. For example, the conditions may be the quality of channel estimation by the UE 115 and a channel correlation of a transmission antenna port when a signal is received by the UE 115 which may depend on the UE 115 location. Currently, there is no mechanism for the network entity 105 to adapt downlink control parameters related to DRMR bundling and precoder cycling to the UE 115 situation that may change over time.

In accordance with examples as described herein, a wireless communications system may implement techniques for adaptation of downlink control parameters. In some examples, the UE 115 may request switching between the downlink control parameters of a precoder cycling and a DMRS bundling for PDCCH. The DMRS bundling may be across REG bundles or inter-control channel element bundles for PDCCH. For example, the UE 115 may transmit, to the network entity 105, a request for a downlink control parameter associated with a control channel. The downlink control parameter may be a precoder cycling or a DMRS bundling. The UE 115 may receive, based on the request, a downlink control message in accordance with the downlink control parameter. In some cases, the request may be transmitted via a physical uplink control channel or a MAC-CE. The request may be transmitted as part of a scheduling request. The request may be activated after confirmation from the network entity or the request may be activated automatically after a processing time. The activated change of switching between precoder cycling and DMRS bundling may be valid for a time duration or may be valid until another indication changes between the precoder cycling and DMRS bundling. In some cases, the UE 115 may receive control signaling indicating a configuration associated with a unitary rotation for a downlink control message. The configuration may indicate one or more resources of a control channel associated with the downlink control message. The configuration may indicate a precoder cycling. The UE 115 may receive the downlink control message via the one or more resources of the control channel, and the downlink control message may have the unitary rotation applied in accordance with the configuration.

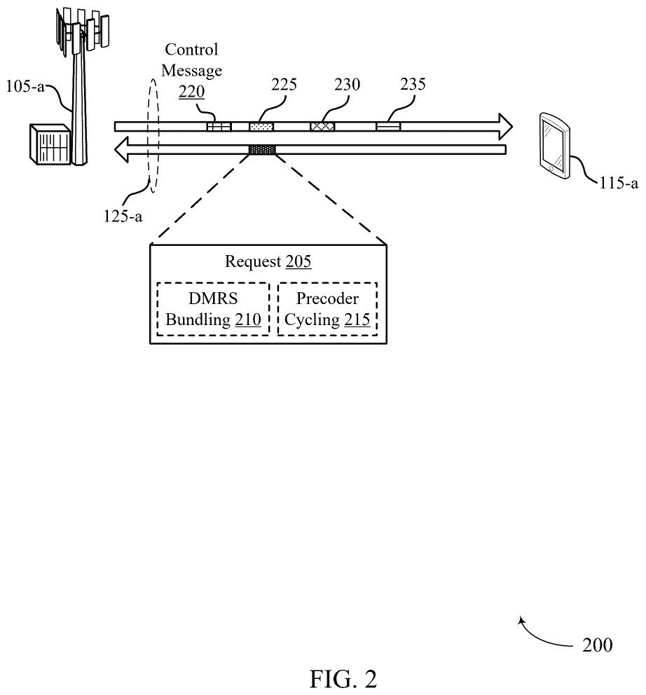

FIG. 2 shows an example of a wireless communications system 200 that supports techniques for adaptation of downlink control parameters in accordance with one or more aspects of the present disclosure. The wireless communications system 200 may implement or may be implemented by aspects of the wireless communications system 100. For example, the wireless communications system 200 may include a UE 115-a, which may be an example of a UE 115 as described herein. The wireless communications system 200 may include a network entity 105-a, which may be an example of a network entity 105 as described herein.

In some examples, the UE 115-a may communicate with the network entity 105-a using a communication link 125-a. The communication link 125-a may be an example of a 6th generation (6G), a NR or LTE link between the UE 115-a and the network entity. The communication link 125-a may include a bi-directional link that enable both uplink and downlink communications. For example, the UE 115-b may transmit uplink signals (e.g., uplink transmissions), such as uplink control signals or uplink data signals, to the network entity 105-a using the communication link 125-a and the network entity 105-a may transmit downlink signals (e.g., downlink transmissions), such as downlink control signals or downlink data signals, to the UE 115-b using the communication link 125-a.

In some examples, the UE 115-a and the network entity 105-a may implement techniques for introducing frequency diversity for control signaling. In 5G NR, DMRS bundling for channel estimation of PDCCH is implemented based on REG bundles that are configured as part of a PDCCH CORESET configuration. If the communication channel associated with the communication link 125-a is not very frequency selective, the quality of the channel estimation may be improved by using more DRMS reference signals, such as using a larger REG bundle or DMRS bundling across REG bundles (or across CCEs). In some cases, a mapping of REG bundles to CCEs inside a CORESET may be distributed (e.g., interleaved) or not distributed (e.g., non-interleaved). Distributed (e.g., interleaved) mapping of REG bundles may better capture frequency selectivity of the channel for transmission or reception of PDCCH. In some cases, non-interleaved REG bundle mapping using precoder cycling among REG bundles, which is transparent to the UE 115-a, may produce different channel gains for different REG bundles which is similar to introducing artificial frequency selectivity with REG bundle steps. For the benefit of frequency diversity, using DMRS bundling across REG bundles without precoder cycling or using precoder cycling may depend on a quality of channel estimation and the amount of useful diversity introduced by precoder cycling. In some cases, the quality of channel estimation may also depend on the UE specific algorithm that is used for the channel estimation. In some cases, the usefulness of precoder cycling may depend on channel correlation of a transmission antenna port when the signal is received by UE 115-a which may depend on UE 115-a location. Because the frequency diversity measures may depend on conditions of the UE 115-a that may change over time (e.g., the UE 115-a channel estimate and the UE 115-a location), the network entity 105-a may adapt the PDCCH transmission parameters. Currently, there is no mechanism for the network entity 105-a to adapt downlink control parameters related to DRMR bundling and precoder cycling to the UE specific situation that may change over time.

In some cases, frequency diversity may be provided by two-symbol unitary rotation. Two-symbol unitary rotation may be applied on symbols from different CCEs that are distant in frequency to exploit frequency diversity for performance enhancement of PDCCH. Two-symbol unitary rotation may be more desirable compared to two-port diversity schemes (e.g., Alamouti) because the two-symbol unitary rotation uses one antenna port.

In some examples, the UE 115-a may request switching between precoder cycling and inter-CCE DMRS bundling (or across REG bundles) for PDCCH. In some cases, the UE 115-a may transmit, to the network entity 105-a, a request 205 for a downlink control parameter associated with a control channel, where the downlink control parameter indicates a DMRS bundling 210 or a precoder cycling 215. In some examples, the request 205 may be transmitted via a physical uplink control channel (PUCCH) or an uplink MAC-CE. For example, the request 205 may be an uplink control channel message. In some examples, the request 205 may be transmitted as part of a scheduling request, and the scheduling request includes the request for the downlink control parameter (e.g., DMRS bundling or precoder cycling). The UE 115-a may receive, based at least in part on the request, a control message 220 (e.g., downlink control message) in accordance with the requested downlink control parameter (e.g., DMRS bundling or precoder cycling).

In some examples, the UE 115-a may receive, from the network entity 105-a, a confirmation 225 for the request for the downlink control parameter. In some cases, the downlink control parameter (e.g., DMRS bundling or precoder cycling) may be activated after the network entity 105-a transmits the confirmation 225 or after the UE 115-a receives the confirmation 225. In some examples, the request for the downlink control parameter may be activated automatically after a processing time. In some examples, the activated change (e.g., switching between precoder cycling and inter-CCE DMRS bundling) may be valid for a predefined or preconfigured period of time. The preconfigured period of time may be received by the UE 115-a in control signaling. In some cases, the activated change (e.g., switching between precoder cycling and inter-CCE DMRS bundling) may be valid until another indication (e.g., another request to change the downlink control parameter) overwrites it. In some cases, the request 205 may be triggered based on a channel signal to noise (SNR) estimate satisfying a threshold. For example, the request 205 may be triggered based on channel estimation SNR estimate (e.g., hypothetical channel estimation SNR). In some cases, the UE 115-a may receive, from the network entity 105-a, a control signal 230 that indicates the threshold. In some examples, the threshold may be configured as part of the CORESET configuration or the search space configuration.

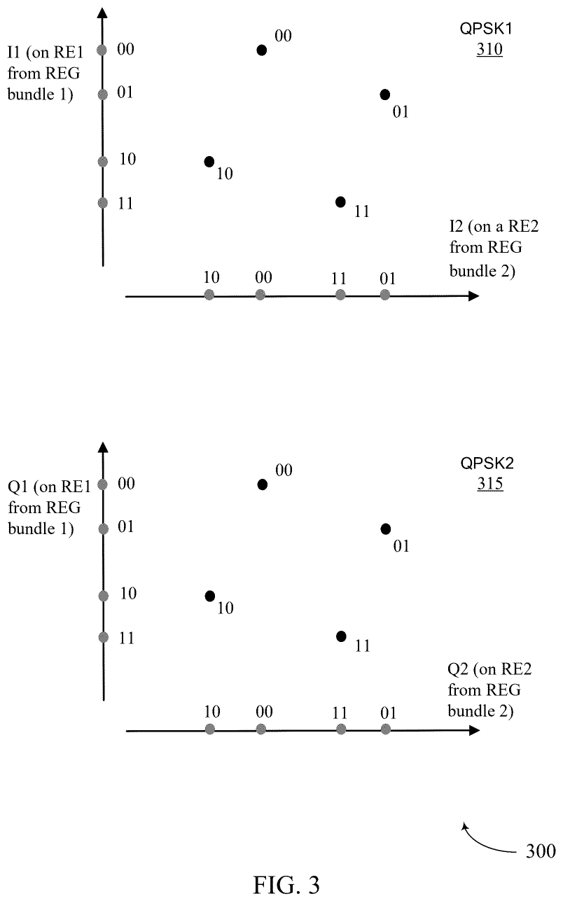

FIG. 3 shows an example of a constellation diagram 300 that supports techniques for adaptation of downlink control parameters in accordance with one or more aspects of the present disclosure. The constellation diagram 300 illustrates an example of two-symbol rotation of two independent quadrature phase shift keying (QPSK) modulation on a rotation of in-phase (e.g., I) and quadrature (e.g., Q) of two REs from two REG bundles. The constellation diagram 300 may implement or be implemented by one or more aspects described with reference to FIGS. 1 and 2. For example, the UE 115-a may receive, from the network entity 105-a, the control message 220 based on the two-symbol rotation to support increased frequency diversity between the UE 115-a and the network entity 105-a.

Referring to FIG. 3, the constellation diagram 300 is a representation of a signal modulated by a digital modulation scheme, such as QPSK. The two symbol rotations of two independent QPSK (e.g., QPSK1 310 and QPSK2 315) on I and Q of two REs from two REG bundles. In some examples, the use of the rotated constellation for the control message 220 may be dependent with the use of precoder cycling or a lack of inter-CCE DMR bundling. In some cases, the two-symbol rotations of two independent QPSK are transmitted on I and Q of two REs from two REG bundles, as shown in FIG. 3, may be conditioned on an assumption of one or multiple of the following factors (or rules based on their combination): presence of precoder cycling, assumption of no DMRS bundling across different REG bundles, or whether mapping of REG bundles to CCEs is distributed or non-distributed.

In some examples, the UE 115-a may receive, from the network entity 105-a, control signaling 235 indicating a configuration associated with a unitary rotation for the control message 220 (e.g., downlink control message). The configuration may indicate one or more resources of a control channel associated with the control message 220, and the configuration may indicate a precoder cycling. The UE 115-a may receive, from the network entity 105-a, the control message 220 via the one or more resources of the control channel, and the control message 220 may have the unitary rotation applied in accordance with the configuration. In some cases, the unitary rotation may include a two-symbol unitary rotation, and the two-symbol unitary rotation may be applied to a QPSK symbol associated with the control channel. The configuration may indicate an absence of DMRS bundling. The configuration may indicate a distributed mapping of REG bundles to CCEs or a non-distributed mapping of REG bundles to CCEs.

In some cases, the conditions, on which the rotated constellation is dependent, may change based on a request from the UE 115-a. For example, the UE 115-a may transmit, to the network entity 105-a, a request for a DMRS bundling. In some examples, the UE 115-a may receive, from the network entity 105-c, a confirmation associated with the request for DMRS bundling. In some cases, the downlink control parameter of DMRS bundling and removal of the two-symbol rotations may be activated after the network entity 105-a transmits the confirmation or after the UE 115-a receives the confirmation. In some examples, the request for the downlink control parameter of DMRS bundling (and removal of the two-symbol rotations) may be activated automatically after the request with a potential predetermined processing time delay based on RRC configuration. In some examples, the activated change may be valid for a predefined or preconfigured period of time.

In some cases, the conditions, on which the rotated constellation is dependent, may change based on the network entity 105-a without request from the UE 115-a. For example, the network entity 105-a may transmit, to the UE 115-a, a second configuration unassociated with the unitary rotation, and the second configuration may indicate one or more second resources of the control channel for a downlink control message. The UE 115-a may receive, from the network entity 105-a, the downlink control message via the one or more second resources of the control channel in accordance with the second configuration.

In accordance with examples as described herein, the wireless communications system 200 may implement rotations of constellations to support increased frequency diversity for signaling between the UE 115-a and the network entity 105-a. In some examples, to implement a rotation for a signal, such as for a control message 220, the network entity 105-a (e.g., or another wireless device) may couple frequency tones associated with the signal with a coupling matrix, which may introduce frequency diversity (e.g., for PDCCH). A frequency tone may refer to a complex valued symbol generated by a transmitter to represent one or more bits of the control message 220. For example, a coupling matrix may be applied as shown in Equation 1 below.

$$[ \begin{matrix}{\tilde{x}}_{1} \\ {\tilde{x}}_{2}\end{matrix} ] = R [ \begin{matrix}{x}_{1} \\ {x}_{2}\end{matrix} ] \qquad ( 1 )$$

In Equation 1, x₁ and x₂ may refer to frequency tones associated with the control message 220 to be transmitted and may correspond (e.g., be assigned) to far-apart resource elements (e.g., in time, with some threshold separation duration), \tilde{x}₁ and \tilde{x}₂ may refer to the frequency tones after the rotation is applied, and R may refer to the coupling matrix, which may correspond to the rotation (e.g., for a Hadamard product, for discrete Fourier transform) applied to the frequency tones x₁ and x₂.

In some examples, the rotation may include a uniform transformation over (e.g., at least) two resource elements (e.g., as in 2×2 MIMO). For example, the uniform transformation may result in a rotation of in-phase (e.g., I) and quadrature (e.g., Q) components of the signal, which may correspond to a two-symbol unitary rotation, and the uniform transformation may be given by Equation 2 below.

$$[ \begin{matrix}{x}_{1}^{′} \\ {x}_{2}^{′}\end{matrix} ] = [ \begin{matrix}cos ( θ ) & - sin ( θ ) \\ sin ( θ ) & cos ( θ )\end{matrix} ] [ \begin{matrix}{x}_{1} \\ {x}_{2}\end{matrix} ] \qquad ( 2 )$$

In Equation 2, x₁ and x₂ may correspond to frequency tones without the rotation applied for a first resource element and a second resource element, θ may correspond to the angle of rotation, and x′₁ and x′₂ may correspond to the frequency rotated tones to be transmitted at the first resource element and the second resource element. In some cases, each of the in-phase and quadrature components (e.g., before the rotation is applied) for a tone transmitted at a resource element k (e.g., k=1,2) may be described as shown in Equation 3 below.

$${x}_{k} = {I}_{k} + j {Q}_{k} \qquad ( 3 )$$

In some examples, after applying the rotation, the rotated in-phase and quadrature components of a frequency tone for each resource element may be based on the original (e.g., pre-rotation) values for the in-phase components for both frequency tones and corresponding resource elements. For example, for the first resource element after the rotation to a first frequency tone, the in-phase component

$$( {I}_{1}^{′} )$$

and the quadrature component

$$( {Q}_{1}^{′} )$$

may be described by Equations 4.1 and 4.2 below.

$${x}_{1}^{′} = {x}_{1} cos θ - {x}_{2} sin ( θ ) \to {I}_{1}^{′} = {I}_{1} cos ( θ ) - {I}_{2} sin ( θ ) \qquad ( 4.1 )$$

$$and {Q}_{1}^{′} = {Q}_{1} cos ( θ ) - {Q}_{2} sin ( θ ) \qquad ( 4.2 )$$

Additionally, for the second resource element after applying the rotation to a second frequency tone, the in-phase component

$$( {I}_{2}^{′} )$$

and the quadrature component

$$( {Q}_{2}^{′} )$$

may be described by Equations 5.1 and 5.2 below.

$${x}_{2}^{′} = {x}_{1} sin θ + {x}_{2} cos ( θ ) \to {I}_{2}^{′} = {I}_{1} sin ( θ ) + {I}_{2} cos ( θ ) \qquad ( 5.1 )$$

$$and {Q}_{2}^{′} = {Q}_{1} sin ( θ ) + {Q}_{2} cos ( θ ) \qquad ( 5.2 )$$

As such, the channel (e.g., D. R=H) for transmission of the control message 220 may be represented by Equation 6 below.

$$[ \begin{matrix}{h}_{1} & 0 \\ 0 & {h}_{2}\end{matrix} ] [ \begin{matrix}cos ( θ ) & - sin ( θ ) \\ sin ( θ ) & cos ( θ )\end{matrix} ] = [ \begin{matrix}{h}_{1} cos ( θ ) ) & - {h}_{2} sin ( θ ) \\ {h}_{2} sin ( θ ) & {h}_{2} cos ( θ )\end{matrix} ] \qquad ( 6 )$$

In some examples, the network entity 105-b may transmit the control signaling 235 indicating a configuration. The configuration may indicate one or more resources for transmission of the control message 220 (e.g., a downlink control message) via a control channel. The configuration may indicate a coupling matrix (e.g., R), a rotation angle, or both, which may be applied to resource elements (e.g., at least two resource elements) of the control channel. Additionally, or alternatively, the coupling matrix, the rotation angle, or both, may be indicated separately, such as via one or more additional signaling (e.g., additional configurations, one or more RRC messages).

In some examples, the configuration may indicate which resource elements associated with the control message 220 may be coupled via the rotation (e.g., for which pairs of resource elements the rotation will be applied). In some cases, the coupling may be based on an aggregation level. For example, for an aggregation level of four, the network entity 105-b may indicate that a first control channel element (CCE) (e.g., CCE1) may be coupled with a third CCE (e.g., CCE3), and a second CCE (e.g., CCE2) may be coupled with a fourth CCE (e.g., CCE4). In another example, for an aggregation level of one, the network entity 105-b may indicate that resource elements in a first half of a control channel element may be coupled with resource elements in a second half of the control channel element. Additionally, or alternatively, the network entity 105-b may indicate coupling in terms of resource element groups (REGs) (e.g., instead of CCEs).

As such, the network entity 105-b may transmit the control message 220 having the unitary rotation applied in accordance with the configuration, such as by using the indicated rotation angle, the indicated coupling matrix, or both. For example, the network entity 105-b may transmit the control message 220 such that a two-symbol unitary rotation is applied across at least one pair of CCEs or at least one pair of REGs, which may enhance frequency diversity of the control message 220. In some examples, the two-symbol unitary rotation may be applied on corresponding symbols (e.g., coupled symbols) on two consecutive CCEs or two consecutive REG bundles (e.g., REG pairs) in a physical downlink control channel (e.g., with interleaved control resource set (CORESET) design).

Additionally, or alternatively, the network entity 105-b may apply the two-symbol unitary rotation to two independent quadrature phase shift keying (QPSK) symbols, applied to two repetitions of a QPSK symbol, or both. In some examples, the two-symbol unitary rotation may be applied to other phase shift keying constellations or quadrature amplitude modulation (QAM) constellations.

In some examples, the rotation angle (e.g., θ) used to apply the two-symbol unitary rotation may be predefined (e.g., instead of indicated via the configuration). For example, a preferred (e.g., optimal) angle may be calculated for a constellation size, which may be associated with a largest gain in frequency diversity. In some examples, the rotation angle may be calculated in accordance with Equations 7 and 8 below.

$$λ = \frac{b}{a} = - tan ( θ ) \qquad ( 7 )$$

$${λ}^{*} = \frac{1 \pm \sqrt{5}}{2} ⇒ {θ}^{*} = atan ( - \frac{1 \pm \sqrt{5}}{2} ) \approx 31.7 deg \qquad ( 8 )$$

As such, the rotation angle may be set to 31.7 degrees (e.g., or another value, such as 31 degrees 30 degrees, or a value within a threshold of 31.7 degrees or another value), and the rotation angle may be configured to the UE 115-a and the network entity 105-a (e.g., configured in a specification) without the rotation angle being signaled by the network entity 105-a. Additionally, or alternatively, the rotation angle may be configured or indicated via different signaling, such as a CORESET configuration, a search space configuration, or both. Signaling the rotation angle may allow for variance of the rotation angle from the optimal angle, which may achieve similar (e.g., slightly decreased) performance for some angles (e.g., angles between 25 and 32 degrees) while allowing for different rotations between transmissions or between UEs 115 or network entities 105.

The UE 115-a may decode the control message 220 based on reversing the rotation. In some cases, prior to reversing the rotation, the UE 115-a may first perform one or more filtering operations, such as a minimum mean square error (MMSE) filter, on each resource element. Then, the two-symbol unitary rotation may be reversed in accordance with Equations 9, 10, and 11, and the UE 115-a may decode the frequency tones for the control message 220.

$$y = H x + n \qquad ( 9 )$$

$$H = D \cdot R \qquad ( 10 )$$

$$\hat{x} = {{H}^{H} ( {HH}^{H} + {N}_{0} I )}^{- 1} y = {R}^{H} {{D}^{H} ( {DRR}^{H} {D}^{h} + {N}_{0} I )}^{- 1} y = {R}^{H} {{D}^{H} ( {DD}^{H} + {N}_{0} I )}^{- 1} y \qquad ( 11 )$$

In Equation 11, R may refer to the coupling matrix, which may be used in accordance with Equation 12 to obtain the frequency tones based on the MMSE filter.

$${{D}^{H} ( D {D}^{H} + {N}_{0} I )}^{- 1} y = [ \begin{matrix}MMSE at tone 1 & 0 \\ 0 & MMSE at tone 2\end{matrix} ] \qquad ( 12 )$$

In some examples, the UE 115-a may use the virtual MIMO channel obtained in accordance with the coupling matrix (e.g., or the rotation angle) to demodulate and obtain LLRs for frequency tones x₁ and x₂, as shown by Equation 13.

$$[ \begin{matrix}{y}_{1} \\ {y}_{2}\end{matrix} ] = [ \begin{matrix}{h}_{1} cos ( θ ) & - {h}_{2} sin ( θ ) \\ {h}_{2} sin ( θ ) & {h}_{2} cos ( θ )\end{matrix} ] [ \begin{matrix}{x}_{1} \\ {x}_{2}\end{matrix} ] + [ \begin{matrix}{n}_{1} \\ {n}_{2}\end{matrix} ] \qquad ( 13 )$$

Additionally, or alternatively, such as in cases with small constellations like QPSK, per-stream recursive demapping (PSRD) may be used (e.g., by the UE 115-a) as a maximum a posteriori probability (MAP) decoder.

Accordingly, by implementing unitary rotations of constellations and supporting signaling to enable transmission and decoding of messages, such as control message 220, utilizing unitary rotation techniques, the wireless communications system 200 may enhance frequency diversity, leading to improved communications between the network entity 105-a and the UE 115-a.

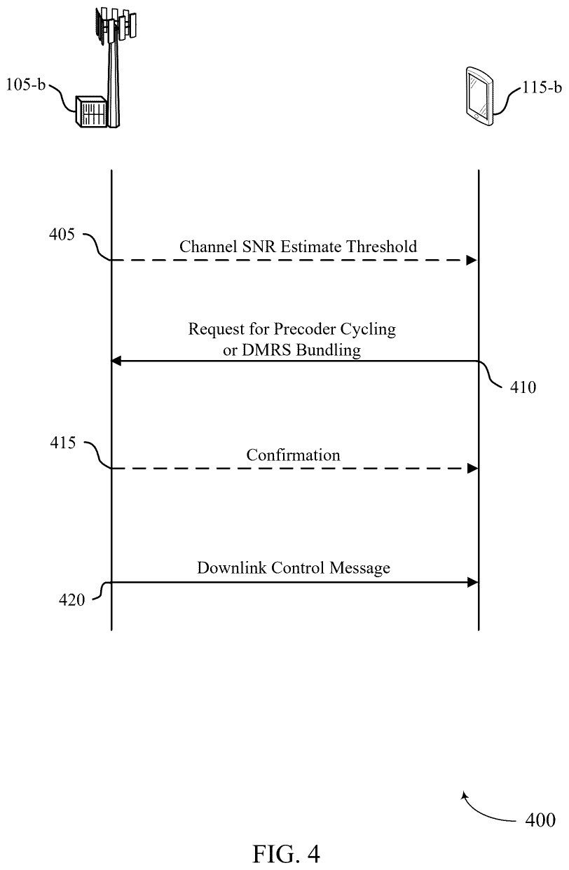

FIG. 4 shows an example of a process flow 400 that supports techniques for adaptation of downlink control parameters in accordance with one or more aspects of the present disclosure. The process flow 400 may implement or may be implemented by aspects of the wireless communications system 100 and the wireless communications system 200. For example, the process flow 400 may include a UE 115-b and a network entity 105-b which may be examples of corresponding devices and entities as described with reference to FIGS. 1 and 2. In the following description of the process flow 400, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 400, and other operations may be added to the process flow 400.

At 405, the UE 115-b may receive, from the network entity 105-b, control signaling that indicates a defined threshold associated with a channel SNR estimate.

At 410, the UE 115-b may transmit, to the network entity 105-b, a request for a downlink control parameter associated with a control channel. The downlink control parameter may indicate one or more of: a precoder cycling or a DMRS bundling. In some cases, the UE 115-b may transmit a control signal indicating the request, where the control signal indicates one or more of: a MAC-CE or and uplink control channel message. In some examples, the UE 115-b may transmit a scheduling request, where the scheduling request includes the request for the downlink control parameter. In some cases, the UE 115-b may transmit the request based on a channel SNR estimate satisfying the defined threshold.

At 415, the UE 115-b may receive, from the network entity 105-b based on the request, a confirmation associated with the request.

At 420, the UE 115-b may receive, from the network entity 105-b based on the request, a downlink control message in accordance with the downlink control parameter. In some cases, the downlink control parameter associated with the request may be valid for a defined time duration. In some examples, the downlink control parameter associated with the request may be valid until an indication of a change to the downlink control parameter is received.

In some cases, the UE 115-b may transmit the request for the precoder cycling, and the UE 115-b may receive control signaling indicating a configuration associated with a unitary rotation for the downlink control message, where the configuration may indicate one or more resources of the control channel associated with the downlink control message. In some cases, the unitary rotation may be a two-symbol unitary rotation. In some examples, the two-symbol unitary rotation may be applied to at least a QPSK symbol associated with the control channel.

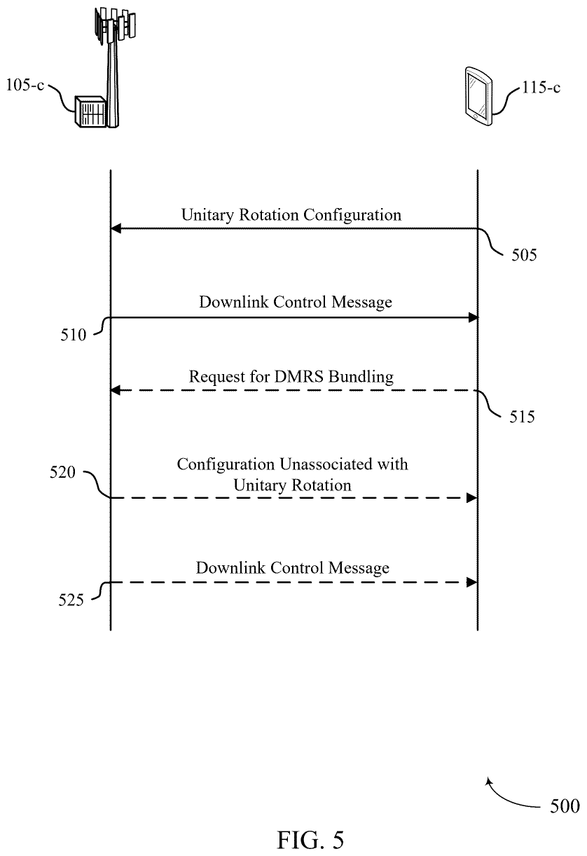

FIG. 5 shows an example of a process flow 500 that supports techniques for adaptation of downlink control parameters in accordance with one or more aspects of the present disclosure. The process flow 500 may implement or may be implemented by aspects of the wireless communications system 100 and the wireless communications system 200. For example, the process flow 500 may include a UE 115-c and a network entity 105-c which may be examples of corresponding devices and entities as described with reference to FIGS. 1 and 2. In the following description of the process flow c00, the operations between the UE 115-c and the network entity 105-c may be transmitted in a different order than the example order shown, or the operations performed by the UE 115-c and the network entity 105-c may be performed in different orders or at different times. Some operations may also be omitted from the process flow 500, and other operations may be added to the process flow 500.

At 505, the UE 115-c may receive, from the network entity 105-c, first control signaling indicating a first configuration associated with a unitary rotation for a first downlink control message. The first configuration may indicate one or more first resources of a control channel associated with the first downlink control message, and the first configuration may indicate a precoder cycling. In some cases, the first configuration may indicate an absence of DMRS bundling. In some examples, the first configuration may indicate a distributed mapping of REG bundles to CCEs or a non-distributed mapping of REG bundles to CCEs.

At 510, the UE 115-c may receive, from the network entity 105-c, the first downlink control message via the one or more first resources of the control channel, and the first downlink control message may have the unitary rotation applied in accordance with the first configuration. In some cases, the unitary rotation comprises a two-symbol unitary rotation. In some examples, the

At 515, the UE 115-c may transmit, to the network entity 105-c, a request for a DMRS bundling.

At 520, the UE 115-c may receive, from the network entity 105-c, a confirmation. In some cases, the configuration may be associated with the request for DMRS bundling. In some cases, the UE 115-c may receive, from the network entity 105-c, control signaling indicating a configuration unassociated with the unitary rotation, and the configuration may indicate one or more second resources of the control channel associated with a second downlink control message.

At 525, the UE 115-c may receive, from the network entity 105-c, a second downlink control message in accordance with the request, where the second downlink control message is exempt from the unitary rotation in accordance with the first configuration. In some cases, the UE 115-c may receive, from the network entity 105-c, second downlink control message via the one or more second resources of the control channel, where the second downlink control message in accordance with the second configuration.

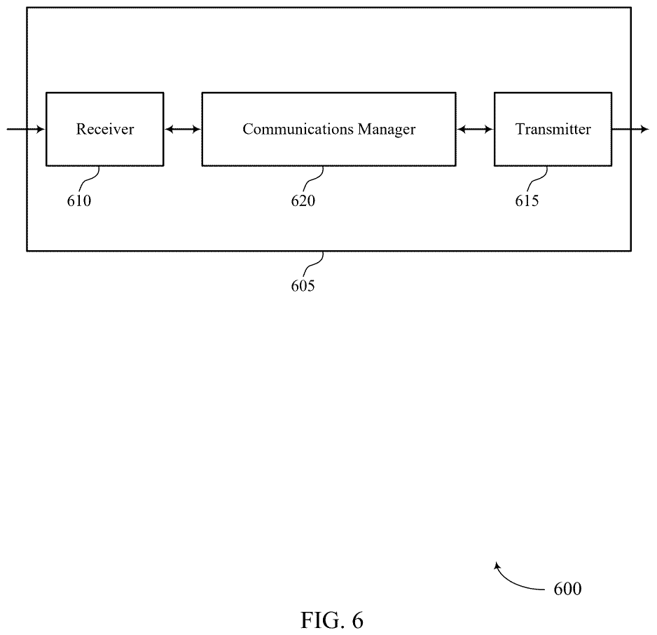

FIG. 6 shows a block diagram 600 of a device 605 that supports techniques for adaptation of downlink control parameters in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for adaptation of downlink control parameters). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for adaptation of downlink control parameters). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of techniques for adaptation of downlink control parameters as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for transmitting a request for a downlink control parameter associated with a control channel, where the downlink control parameter indicates one or more of: a precoder cycling or a DMRS bundling. The communications manager 620 is capable of, configured to, or operable to support a means for receiving, based on the request, a downlink control message in accordance with the downlink control parameter.

Additionally, or alternatively, the communications manager 620 may support wireless communications in accordance with examples as disclosed herein. For example, the communications manager 620 is capable of, configured to, or operable to support a means for receiving first control signaling indicating a first configuration associated with a unitary rotation for a first downlink control message, the first configuration indicating one or more first resources of a control channel associated with the first downlink control message, where the first configuration indicates a precoder cycling. The communications manager 620 is capable of, configured to, or operable to support a means for receiving the first downlink control message via the one or more first resources of the control channel, the first downlink control message having the unitary rotation applied in accordance with the first configuration.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for more efficient utilization of communication resources.

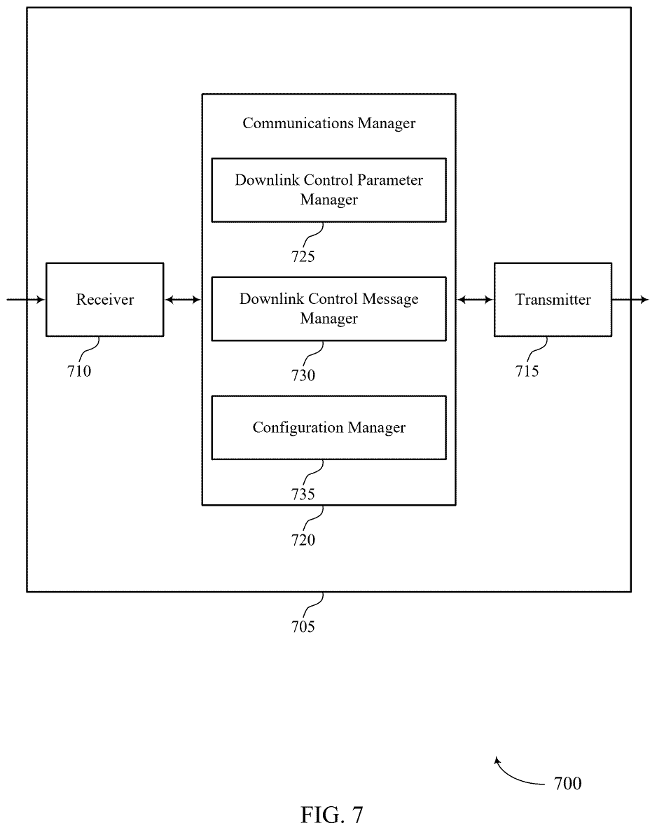

FIG. 7 shows a block diagram 700 of a device 705 that supports techniques for adaptation of downlink control parameters in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for adaptation of downlink control parameters). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for adaptation of downlink control parameters). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for adaptation of downlink control parameters as described herein. For example, the communications manager 720 may include a downlink control parameter manager 725, a downlink control message manager 730, a configuration manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The downlink control parameter manager 725 is capable of, configured to, or operable to support a means for transmitting a request for a downlink control parameter associated with a control channel, where the downlink control parameter indicates one or more of: a precoder cycling or a DMRS bundling. The downlink control message manager 730 is capable of, configured to, or operable to support a means for receiving, based on the request, a downlink control message in accordance with the downlink control parameter.

Additionally, or alternatively, the communications manager 720 may support wireless communications in accordance with examples as disclosed herein. The configuration manager 735 is capable of, configured to, or operable to support a means for receiving first control signaling indicating a first configuration associated with a unitary rotation for a first downlink control message, the first configuration indicating one or more first resources of a control channel associated with the first downlink control message, where the first configuration indicates a precoder cycling. The downlink control message manager 730 is capable of, configured to, or operable to support a means for receiving the first downlink control message via the one or more first resources of the control channel, the first downlink control message having the unitary rotation applied in accordance with the first configuration.

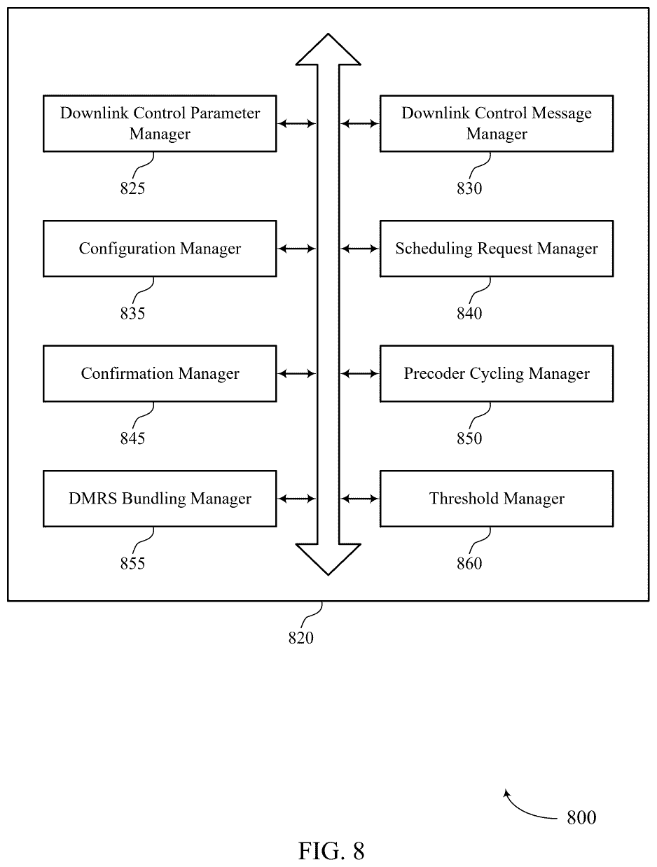

FIG. 8 shows a block diagram 800 of a communications manager 820 that supports techniques for adaptation of downlink control parameters in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for adaptation of downlink control parameters as described herein. For example, the communications manager 820 may include a downlink control parameter manager 825, a downlink control message manager 830, a configuration manager 835, a scheduling request manager 840, a confirmation manager 845, a precoder cycling manager 850, a DMRS bundling manager 855, a threshold manager 860, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The downlink control parameter manager 825 is capable of, configured to, or operable to support a means for transmitting a request for a downlink control parameter associated with a control channel, where the downlink control parameter indicates one or more of: a precoder cycling or a DMRS bundling. The downlink control message manager 830 is capable of, configured to, or operable to support a means for receiving, based on the request, a downlink control message in accordance with the downlink control parameter.

In some examples, to support transmitting the request, the downlink control parameter manager 825 is capable of, configured to, or operable to support a means for transmitting a control signal indicating the request, where the control signal indicates one or more of: a medium access control-control element (MAC-CE) or an uplink control channel message.

In some examples, to support transmitting the request, the scheduling request manager 840 is capable of, configured to, or operable to support a means for transmitting a scheduling request, where the scheduling request includes the request for the downlink control parameter.

In some examples, the confirmation manager 845 is capable of, configured to, or operable to support a means for receiving, based on the request, a confirmation associated with the request.

In some examples, the downlink control parameter associated with the request is valid for a defined time duration.

In some examples, the downlink control parameter associated with the request is valid until an indication of a change to the downlink control parameter is received.

In some examples, to support transmitting the request, the downlink control parameter manager 825 is capable of, configured to, or operable to support a means for transmitting the request based on a channel SNR estimate satisfying a defined threshold.

In some examples, the threshold manager 860 is capable of, configured to, or operable to support a means for receiving control signaling that indicates the defined threshold.

In some examples, to support transmitting the request, the precoder cycling manager 850 is capable of, configured to, or operable to support a means for transmitting the request for the precoder cycling. In some examples, to support transmitting the request, the configuration manager 835 is capable of, configured to, or operable to support a means for receiving, based on the request, control signaling indicating a configuration associated with a unitary rotation for the downlink control message, the configuration indicating one or more resources of the control channel associated with the downlink control message.

In some examples, the unitary rotation includes a two-symbol unitary rotation.

In some examples, the two-symbol unitary rotation is applied to at least a quadrature phase shift keying (QPSK) symbol associated with the control channel.

Additionally, or alternatively, the communications manager 820 may support wireless communications in accordance with examples as disclosed herein. The configuration manager 835 is capable of, configured to, or operable to support a means for receiving first control signaling indicating a first configuration associated with a unitary rotation for a first downlink control message, the first configuration indicating one or more first resources of a control channel associated with the first downlink control message, where the first configuration indicates a precoder cycling. In some examples, the downlink control message manager 830 is capable of, configured to, or operable to support a means for receiving the first downlink control message via the one or more first resources of the control channel, the first downlink control message having the unitary rotation applied in accordance with the first configuration.

In some examples, the unitary rotation includes a two-symbol unitary rotation.

In some examples, the two-symbol unitary rotation is applied to at least a quadrature phase shift keying (QPSK) symbol associated with the control channel.

In some examples, the first configuration indicates an absence of DMRS bundling.

In some examples, the first configuration indicates a distributed mapping of resource element group (REG) bundles to control channel elements (CCEs) or a non-distributed mapping is distributed or non-distributed mapping of REG bundles to CCEs.

In some examples, the DMRS bundling manager 855 is capable of, configured to, or operable to support a means for transmitting a request for a DMRS bundling. In some examples, the confirmation manager 845 is capable of, configured to, or operable to support a means for receiving, based on the request, a confirmation associated with the request.

In some examples, the DMRS bundling manager 855 is capable of, configured to, or operable to support a means for transmitting, subsequent to the first control signaling, a request for a DMRS bundling. In some examples, the downlink control message manager 830 is capable of, configured to, or operable to support a means for receiving, based on the request, a second downlink control message in accordance with the request, where the second downlink control message is exempt from the unitary rotation in accordance with the first configuration.

In some examples, the configuration manager 835 is capable of, configured to, or operable to support a means for receiving second control signaling indicating a second configuration unassociated with the unitary rotation, the second configuration indicating one or more second resources of the control channel associated with a second downlink control message. In some examples, the downlink control message manager 830 is capable of, configured to, or operable to support a means for receiving the second downlink control message via the one or more second resources of the control channel, the second downlink control message in accordance with the second configuration.

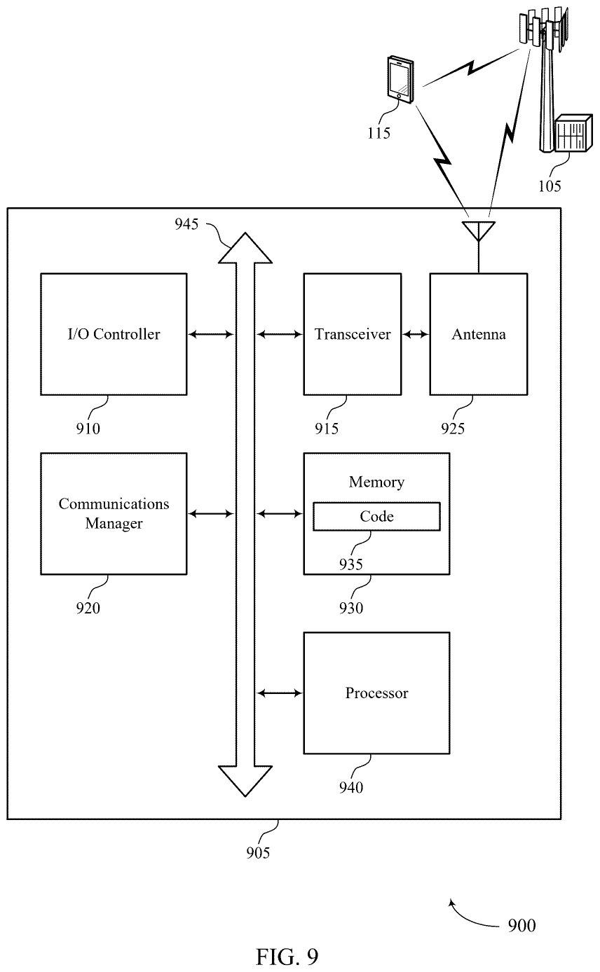

FIG. 9 shows a diagram of a system 900 including a device 905 that supports techniques for adaptation of downlink control parameters in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting techniques for adaptation of downlink control parameters). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for transmitting a request for a downlink control parameter associated with a control channel, where the downlink control parameter indicates one or more of: a precoder cycling or a DMRS bundling. The communications manager 920 is capable of, configured to, or operable to support a means for receiving, based on the request, a downlink control message in accordance with the downlink control parameter.

Additionally, or alternatively, the communications manager 920 may support wireless communications in accordance with examples as disclosed herein. For example, the communications manager 920 is capable of, configured to, or operable to support a means for receiving first control signaling indicating a first configuration associated with a unitary rotation for a first downlink control message, the first configuration indicating one or more first resources of a control channel associated with the first downlink control message, where the first configuration indicates a precoder cycling. The communications manager 920 is capable of, configured to, or operable to support a means for receiving the first downlink control message via the one or more first resources of the control channel, the first downlink control message having the unitary rotation applied in accordance with the first configuration.

By including or configuring the communications manager 920 in accordance with examples as described herein, the device 905 may support techniques for more efficient utilization of communication resources and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of techniques for adaptation of downlink control parameters as described herein, or the at least one processor 940 and the at least one memory 930 may be otherwise configured to, individually or collectively, perform or support such operations.

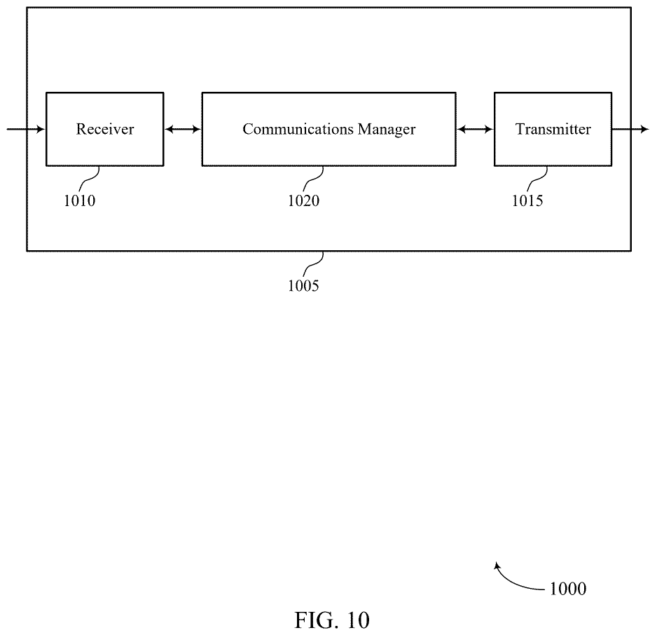

FIG. 10 shows a block diagram 1000 of a device 1005 that supports techniques for adaptation of downlink control parameters in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of techniques for adaptation of downlink control parameters as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for obtaining a request for a downlink control parameter associated with a control channel, where the downlink control parameter indicates one or more of: a precoder cycling or a DMRS bundling. The communications manager 1020 is capable of, configured to, or operable to support a means for outputting, based on the request, a downlink control message in accordance with the downlink control parameter.

Additionally, or alternatively, the communications manager 1020 may support wireless communications in accordance with examples as disclosed herein. For example, the communications manager 1020 is capable of, configured to, or operable to support a means for outputting first control signaling indicating a first configuration associated with a unitary rotation for a first downlink control message, the first configuration indicating one or more first resources of a control channel associated with the first downlink control message, where the first configuration indicates a precoder cycling. The communications manager 1020 is capable of, configured to, or operable to support a means for outputting the first downlink control message via the one or more first resources of the control channel, the first downlink control message having the unitary rotation applied in accordance with the first configuration.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for more efficient utilization of communication resources.

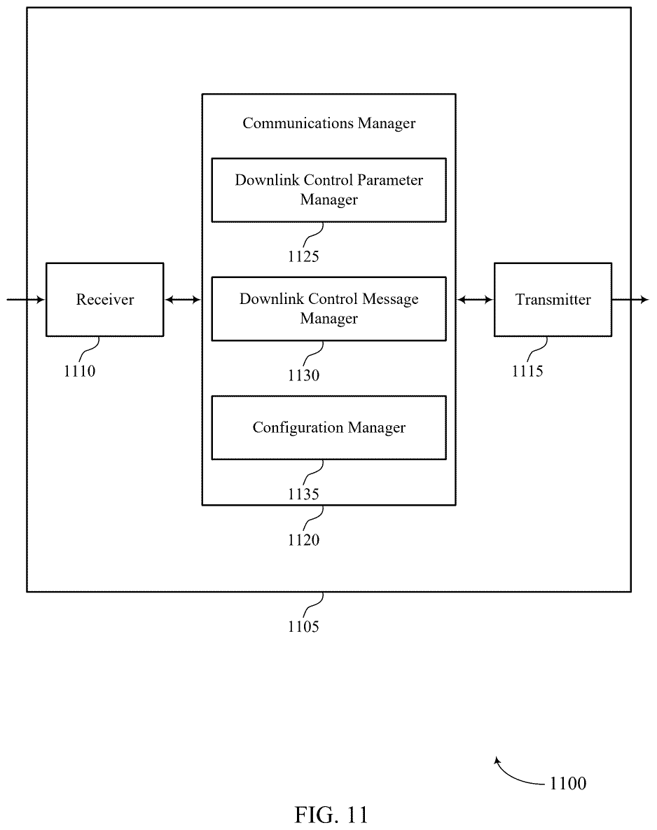

FIG. 11 shows a block diagram 1100 of a device 1105 that supports techniques for adaptation of downlink control parameters in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for adaptation of downlink control parameters as described herein. For example, the communications manager 1120 may include a downlink control parameter manager 1125, a downlink control message manager 1130, a configuration manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The downlink control parameter manager 1125 is capable of, configured to, or operable to support a means for obtaining a request for a downlink control parameter associated with a control channel, where the downlink control parameter indicates one or more of: a precoder cycling or a DMRS bundling. The downlink control message manager 1130 is capable of, configured to, or operable to support a means for outputting, based on the request, a downlink control message in accordance with the downlink control parameter.

Additionally, or alternatively, the communications manager 1120 may support wireless communications in accordance with examples as disclosed herein. The configuration manager 1135 is capable of, configured to, or operable to support a means for outputting first control signaling indicating a first configuration associated with a unitary rotation for a first downlink control message, the first configuration indicating one or more first resources of a control channel associated with the first downlink control message, where the first configuration indicates a precoder cycling. The downlink control message manager 1130 is capable of, configured to, or operable to support a means for outputting the first downlink control message via the one or more first resources of the control channel, the first downlink control message having the unitary rotation applied in accordance with the first configuration.

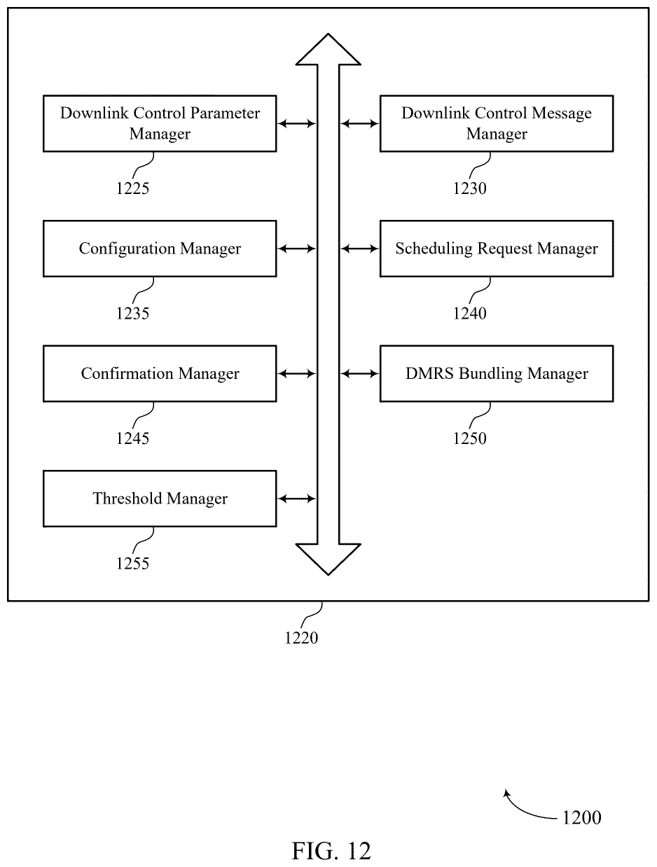

FIG. 12 shows a block diagram 1200 of a communications manager 1220 that supports techniques for adaptation of downlink control parameters in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for adaptation of downlink control parameters as described herein. For example, the communications manager 1220 may include a downlink control parameter manager 1225, a downlink control message manager 1230, a configuration manager 1235, a scheduling request manager 1240, a confirmation manager 1245, a DMRS bundling manager 1250, a threshold manager 1255, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The downlink control parameter manager 1225 is capable of, configured to, or operable to support a means for obtaining a request for a downlink control parameter associated with a control channel, where the downlink control parameter indicates one or more of: a precoder cycling or a DMRS bundling. The downlink control message manager 1230 is capable of, configured to, or operable to support a means for outputting, based on the request, a downlink control message in accordance with the downlink control parameter.

In some examples, to support obtaining the request, the downlink control parameter manager 1225 is capable of, configured to, or operable to support a means for obtaining a control signal indicating the request, where the control signal indicates one or more of: a medium access control-control element (MAC-CE) or an uplink control channel message.

In some examples, to support obtaining the request, the scheduling request manager 1240 is capable of, configured to, or operable to support a means for obtaining a scheduling request, where the scheduling request includes the request for the downlink control parameter.

In some examples, the confirmation manager 1245 is capable of, configured to, or operable to support a means for outputting, based on the request, a confirmation associated with the request.

In some examples, the downlink control parameter associated with the request is valid for a defined time duration.

In some examples, the downlink control parameter associated with the request is valid until an indication of a change to the downlink control parameter is received.

In some examples, to support obtaining the request, the downlink control parameter manager 1225 is capable of, configured to, or operable to support a means for obtaining the request based on a channel SNR estimate satisfying a defined threshold.

In some examples, the threshold manager 1255 is capable of, configured to, or operable to support a means for outputting control signaling that indicates the defined threshold.

In some examples, to support obtaining the request, the downlink control parameter manager 1225 is capable of, configured to, or operable to support a means for obtaining the request for the precoder cycling. In some examples, to support obtaining the request, the configuration manager 1235 is capable of, configured to, or operable to support a means for outputting, based on the request, control signaling indicating a configuration associated with a unitary rotation for the downlink control message, the configuration indicating one or more resources of the control channel associated with the downlink control message.

In some examples, the unitary rotation includes a two-symbol unitary rotation.

In some examples, the two-symbol unitary rotation is applied to at least a quadrature phase shift keying (QPSK) symbol associated with the control channel.

Additionally, or alternatively, the communications manager 1220 may support wireless communications in accordance with examples as disclosed herein. The configuration manager 1235 is capable of, configured to, or operable to support a means for outputting first control signaling indicating a first configuration associated with a unitary rotation for a first downlink control message, the first configuration indicating one or more first resources of a control channel associated with the first downlink control message, where the first configuration indicates a precoder cycling. In some examples, the downlink control message manager 1230 is capable of, configured to, or operable to support a means for outputting the first downlink control message via the one or more first resources of the control channel, the first downlink control message having the unitary rotation applied in accordance with the first configuration.

In some examples, the unitary rotation includes a two-symbol unitary rotation.

In some examples, the two-symbol unitary rotation is applied to at least a quadrature phase shift keying (QPSK) symbol associated with the control channel.

In some examples, the first configuration indicates an absence of DMRS bundling.

In some examples, the first configuration indicates a distributed mapping of resource element group (REG) bundles to control channel elements (CCEs) or a non-distributed mapping is distributed or non-distributed mapping of REG bundles to CCEs.

In some examples, the DMRS bundling manager 1250 is capable of, configured to, or operable to support a means for obtaining a request for a DMRS bundling. In some examples, the confirmation manager 1245 is capable of, configured to, or operable to support a means for outputting, based on the request, a confirmation associated with the request.

In some examples, the DMRS bundling manager 1250 is capable of, configured to, or operable to support a means for obtaining, subsequent to the first control signaling, a request for a DMRS bundling. In some examples, the downlink control message manager 1230 is capable of, configured to, or operable to support a means for outputting, based on the request, a second downlink control message in accordance with the request, where the second downlink control message is exempt from the unitary rotation in accordance with the first configuration.

In some examples, the configuration manager 1235 is capable of, configured to, or operable to support a means for outputting second control signaling indicating a second configuration unassociated with the unitary rotation, the second configuration indicating one or more second resources of the control channel associated with a second downlink control message. In some examples, the downlink control message manager 1230 is capable of, configured to, or operable to support a means for outputting the second downlink control message via the one or more second resources of the control channel, the second downlink control message in accordance with the second configuration.

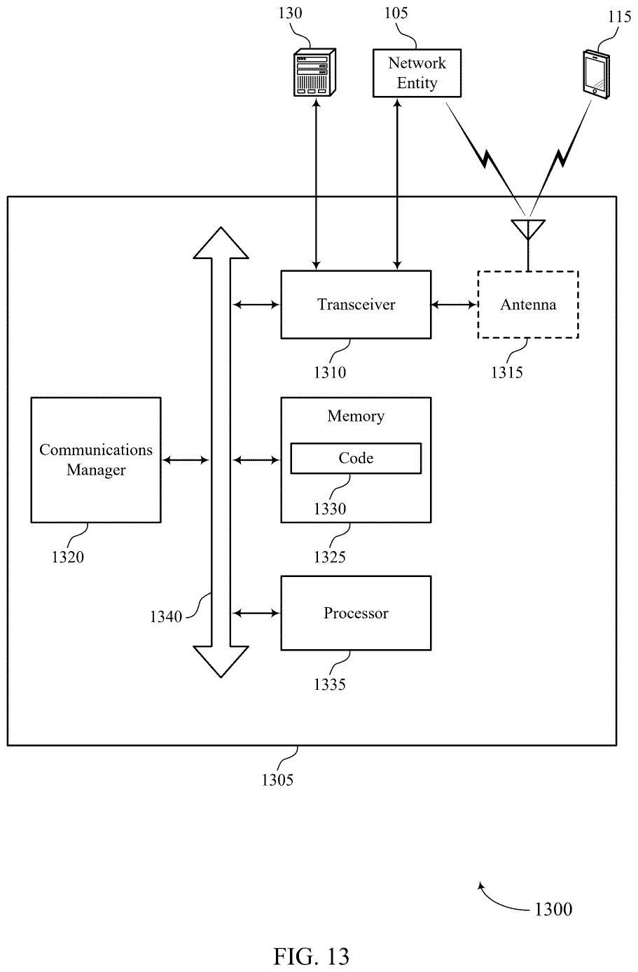

FIG. 13 shows a diagram of a system 1300 including a device 1305 that supports techniques for adaptation of downlink control parameters in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting techniques for adaptation of downlink control parameters). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for obtaining a request for a downlink control parameter associated with a control channel, where the downlink control parameter indicates one or more of: a precoder cycling or a DMRS bundling. The communications manager 1320 is capable of, configured to, or operable to support a means for outputting, based on the request, a downlink control message in accordance with the downlink control parameter.

Additionally, or alternatively, the communications manager 1320 may support wireless communications in accordance with examples as disclosed herein. For example, the communications manager 1320 is capable of, configured to, or operable to support a means for outputting first control signaling indicating a first configuration associated with a unitary rotation for a first downlink control message, the first configuration indicating one or more first resources of a control channel associated with the first downlink control message, where the first configuration indicates a precoder cycling. The communications manager 1320 is capable of, configured to, or operable to support a means for outputting the first downlink control message via the one or more first resources of the control channel, the first downlink control message having the unitary rotation applied in accordance with the first configuration.

By including or configuring the communications manager 1320 in accordance with examples as described herein, the device 1305 may support techniques for more efficient utilization of communication resources and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of techniques for adaptation of downlink control parameters as described herein, or the at least one processor 1335 and the at least one memory 1325 may be otherwise configured to, individually or collectively, perform or support such operations.

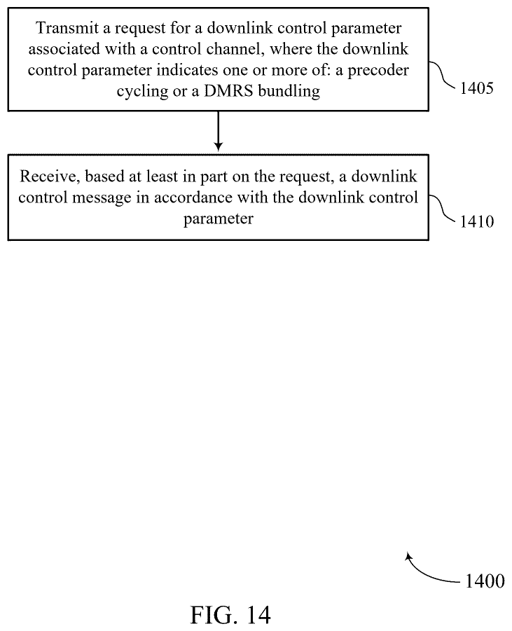

FIG. 14 shows a flowchart illustrating a method 1400 that supports techniques for adaptation of downlink control parameters in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include transmitting a request for a downlink control parameter associated with a control channel, where the downlink control parameter indicates one or more of: a precoder cycling or a DMRS bundling. The operations of 1405 may be performed in accordance with examples as disclosed herein. In some examples, aspects of the operations of 1405 may be performed by a downlink control parameter manager 825 as described with reference to FIG. 8.

At 1410, the method may include receiving, based at least in part on the request, a downlink control message in accordance with the downlink control parameter. The operations of 1410 may be performed in accordance with examples as disclosed herein. In some examples, aspects of the operations of 1410 may be performed by a downlink control message manager 830 as described with reference to FIG. 8.

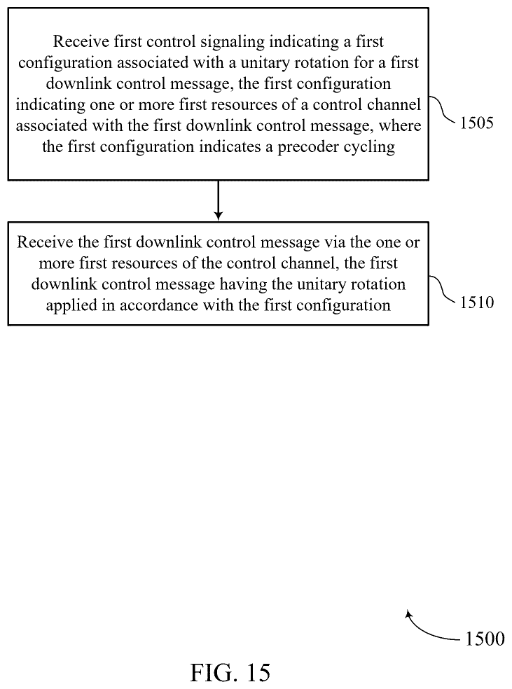

FIG. 15 shows a flowchart illustrating a method 1500 that supports techniques for adaptation of downlink control parameters in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving first control signaling indicating a first configuration associated with a unitary rotation for a first downlink control message, the first configuration indicating one or more first resources of a control channel associated with the first downlink control message, where the first configuration indicates a precoder cycling. The operations of 1505 may be performed in accordance with examples as disclosed herein. In some examples, aspects of the operations of 1505 may be performed by a configuration manager 835 as described with reference to FIG. 8.

At 1510, the method may include receiving the first downlink control message via the one or more first resources of the control channel, the first downlink control message having the unitary rotation applied in accordance with the first configuration. The operations of 1510 may be performed in accordance with examples as disclosed herein. In some examples, aspects of the operations of 1510 may be performed by a downlink control message manager 830 as described with reference to FIG. 8.

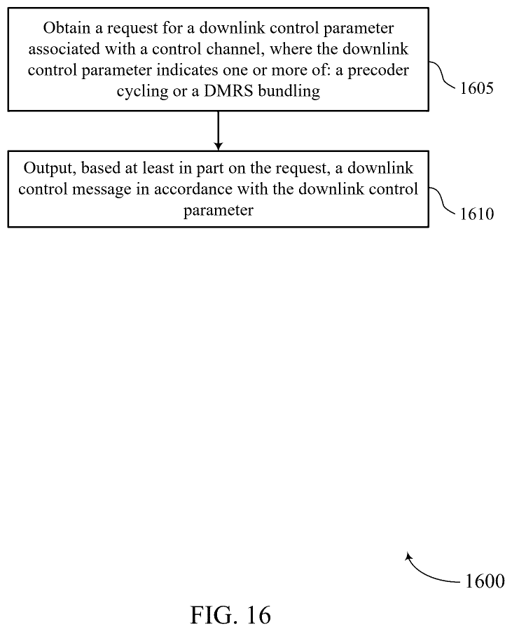

FIG. 16 shows a flowchart illustrating a method 1600 that supports techniques for adaptation of downlink control parameters in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include obtaining a request for a downlink control parameter associated with a control channel, where the downlink control parameter indicates one or more of: a precoder cycling or a DMRS bundling. The operations of 1605 may be performed in accordance with examples as disclosed herein. In some examples, aspects of the operations of 1605 may be performed by a downlink control parameter manager 1225 as described with reference to FIG. 12.

At 1610, the method may include outputting, based at least in part on the request, a downlink control message in accordance with the downlink control parameter. The operations of 1610 may be performed in accordance with examples as disclosed herein. In some examples, aspects of the operations of 1610 may be performed by a downlink control message manager 1230 as described with reference to FIG. 12.

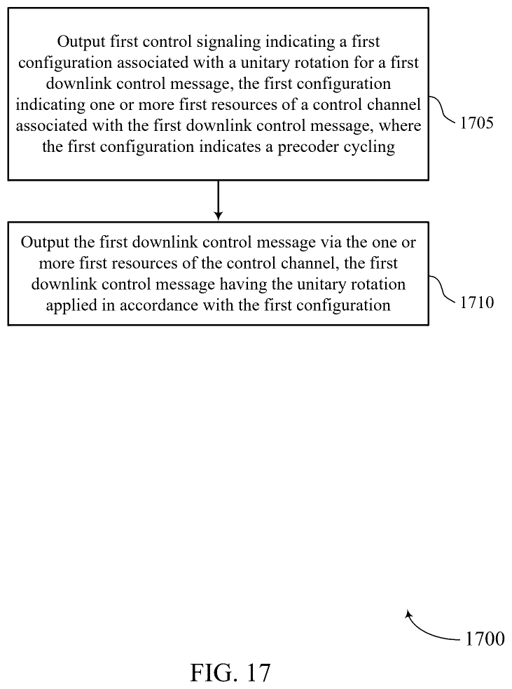

FIG. 17 shows a flowchart illustrating a method 1700 that supports techniques for adaptation of downlink control parameters in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include outputting first control signaling indicating a first configuration associated with a unitary rotation for a first downlink control message, the first configuration indicating one or more first resources of a control channel associated with the first downlink control message, where the first configuration indicates a precoder cycling. The operations of 1705 may be performed in accordance with examples as disclosed herein. In some examples, aspects of the operations of 1705 may be performed by a configuration manager 1235 as described with reference to FIG. 12.

At 1710, the method may include outputting the first downlink control message via the one or more first resources of the control channel, the first downlink control message having the unitary rotation applied in accordance with the first configuration. The operations of 1710 may be performed in accordance with examples as disclosed herein. In some examples, aspects of the operations of 1710 may be performed by a downlink control message manager 1230 as described with reference to FIG. 12.

The following provides an overview of aspects of the present disclosure:

Aspect 1: A method for wireless communications by a UE, comprising: transmitting a request for a downlink control parameter associated with a control channel, wherein the downlink control parameter indicates one or more of: a precoder cycling or a DMRS bundling; and receiving, based at least in part on the request, a downlink control message in accordance with the downlink control parameter.

Aspect 2: The method of aspect 1, wherein transmitting the request comprises: transmitting a control signal indicating the request, wherein the control signal indicates one or more of: a MAC-CE or an uplink control channel message.

Aspect 3: The method of aspect 1, wherein transmitting the request comprises: transmitting a scheduling request, wherein the scheduling request comprises the request for the downlink control parameter.

Aspect 4: The method of aspect 1, further comprising: receiving, based at least in part on the request, a confirmation associated with the request.

Aspect 5: The method of aspect 1, wherein the downlink control parameter associated with the request is valid for a defined time duration.

Aspect 6: The method of aspect 1, wherein the downlink control parameter associated with the request is valid until an indication of a change to the downlink control parameter is received.

Aspect 7: The method of aspect 1, wherein transmitting the request comprises: transmitting the request based at least in part on a channel SNR estimate satisfying a defined threshold.

Aspect 8: The method of aspect 7, further comprising: receiving control signaling that indicates the defined threshold.

Aspect 9: The method of aspect 1, wherein transmitting the request comprises: transmitting the request for the precoder cycling; and receiving, based at least in part on the request, control signaling indicating a configuration associated with a unitary rotation for the downlink control message, the configuration indicating one or more resources of the control channel associated with the downlink control message.

Aspect 10: The method of aspect 9, wherein the unitary rotation comprises a two-symbol unitary rotation.

Aspect 11: The method of aspect 10, wherein the two-symbol unitary rotation is applied to at least a QPSK symbol associated with the control channel.

Aspect 12: A method for wireless communications by a UE, comprising: receiving first control signaling indicating a first configuration associated with a unitary rotation for a first downlink control message, the first configuration indicating one or more first resources of a control channel associated with the first downlink control message, wherein the first configuration indicates a precoder cycling; and receiving the first downlink control message via the one or more first resources of the control channel, the first downlink control message having the unitary rotation applied in accordance with the first configuration.

Aspect 13: The method of aspect 12, wherein the unitary rotation comprises a two-symbol unitary rotation.

Aspect 14: The method of aspect 13, wherein the two-symbol unitary rotation is applied to at least a QPSK symbol associated with the control channel.

Aspect 15: The method of any of aspects 12 through 14, wherein the first configuration indicates an absence of DMRS bundling.

Aspect 16: The method of any of aspects 12 through 15, wherein the first configuration indicates a distributed mapping of REG bundles to CCEs or a non-distributed mapping is distributed or non-distributed mapping of REG bundles to CCEs.

Aspect 17: The method of aspect 12, further comprising: transmitting a request for a DMRS bundling; and receiving, based at least in part on the request, a confirmation associated with the request.

Aspect 18: The method of aspect 12, further comprising: transmitting, subsequent to the first control signaling, a request for a DMRS bundling; and receiving, based at least in part on the request, a second downlink control message in accordance with the request, wherein the second downlink control message is exempt from the unitary rotation in accordance with the first configuration.

Aspect 19: The method of aspect 12, further comprising: receiving second control signaling indicating a second configuration unassociated with the unitary rotation, the second configuration indicating one or more second resources of the control channel associated with a second downlink control message; and receiving the second downlink control message via the one or more second resources of the control channel, the second downlink control message in accordance with the second configuration.

Aspect 20: A method for wireless communications by a network entity, comprising: obtaining a request for a downlink control parameter associated with a control channel, wherein the downlink control parameter indicates one or more of: a precoder cycling or a DMRS bundling; and outputting, based at least in part on the request, a downlink control message in accordance with the downlink control parameter.

Aspect 21: The method of aspect 20, wherein obtaining the request comprises: obtaining a control signal indicating the request, wherein the control signal indicates one or more of: a MAC-CE or an uplink control channel message.

Aspect 22: The method of aspect 20, wherein obtaining the request comprises: obtaining a scheduling request, wherein the scheduling request comprises the request for the downlink control parameter.

Aspect 23: The method of aspect 20, further comprising: outputting, based at least in part on the request, a confirmation associated with the request.

Aspect 24: The method of aspect 20, wherein the downlink control parameter associated with the request is valid for a defined time duration.

Aspect 25: The method of aspect 20, wherein the downlink control parameter associated with the request is valid until an indication of a change to the downlink control parameter is received.

Aspect 26: The method of aspect 20, wherein obtaining the request comprises: obtaining the request based at least in part on a channel SNR estimate satisfying a defined threshold.

Aspect 27: The method of aspect 26, further comprising: outputting control signaling that indicates the defined threshold.

Aspect 28: The method of aspect 20, wherein obtaining the request comprises: obtaining the request for the precoder cycling; and outputting, based at least in part on the request, control signaling indicating a configuration associated with a unitary rotation for the downlink control message, the configuration indicating one or more resources of the control channel associated with the downlink control message.

Aspect 29: The method of aspect 28, wherein the unitary rotation comprises a two-symbol unitary rotation.

Aspect 30: The method of aspect 29, wherein the two-symbol unitary rotation is applied to at least a QPSK symbol associated with the control channel.

Aspect 31: A method for wireless communications by a network entity, comprising: outputting first control signaling indicating a first configuration associated with a unitary rotation for a first downlink control message, the first configuration indicating one or more first resources of a control channel associated with the first downlink control message, wherein the first configuration indicates a precoder cycling; and outputting the first downlink control message via the one or more first resources of the control channel, the first downlink control message having the unitary rotation applied in accordance with the first configuration.

Aspect 32: The method of aspect 31, wherein the unitary rotation comprises a two-symbol unitary rotation.

Aspect 33: The method of aspect 32, wherein the two-symbol unitary rotation is applied to at least a QPSK symbol associated with the control channel.

Aspect 34: The method of any of aspects 31 through 33, wherein the first configuration indicates an absence of DMRS bundling.

Aspect 35: The method of any of aspects 31 through 34, wherein the first configuration indicates a distributed mapping of REG bundles to CCEs or a non-distributed mapping is distributed or non-distributed mapping of REG bundles to CCEs.

Aspect 36: The method of aspect 31, further comprising: obtaining a request for a DMRS bundling; and outputting, based at least in part on the request, a confirmation associated with the request.

Aspect 37: The method of aspect 31, further comprising: obtaining, subsequent to the first control signaling, a request for a DMRS bundling; and outputting, based at least in part on the request, a second downlink control message in accordance with the request, wherein the second downlink control message is exempt from the unitary rotation in accordance with the first configuration.

Aspect 38: The method of aspect 31, further comprising: outputting second control signaling indicating a second configuration unassociated with the unitary rotation, the second configuration indicating one or more second resources of the control channel associated with a second downlink control message; and outputting the second downlink control message via the one or more second resources of the control channel, the second downlink control message in accordance with the second configuration.

Aspect 39: A UE for wireless communications, comprising one or more memories storing processor-executable code, and one or more processors coupled with the one or more memories and individually or collectively operable to execute the code to cause the UE to perform a method of any of aspects 1 through 11.

Aspect 40: A UE for wireless communications, comprising at least one means for performing a method of any of aspects 1 through 11.

Aspect 41: A non-transitory computer-readable medium storing code for wireless communications, the code comprising instructions executable by one or more processors to perform a method of any of aspects 1 through 11.

Aspect 42: A UE for wireless communications, comprising one or more memories storing processor-executable code, and one or more processors coupled with the one or more memories and individually or collectively operable to execute the code to cause the UE to perform a method of any of aspects 12 through 19.

Aspect 43: A UE for wireless communications, comprising at least one means for performing a method of any of aspects 12 through 19.

Aspect 44: A non-transitory computer-readable medium storing code for wireless communications, the code comprising instructions executable by one or more processors to perform a method of any of aspects 12 through 19.

Aspect 45: A network entity for wireless communications, comprising one or more memories storing processor-executable code, and one or more processors coupled with the one or more memories and individually or collectively operable to execute the code to cause the network entity to perform a method of any of aspects 20 through 30.

Aspect 46: A network entity for wireless communications, comprising at least one means for performing a method of any of aspects 20 through 30.

Aspect 47: A non-transitory computer-readable medium storing code for wireless communications, the code comprising instructions executable by one or more processors to perform a method of any of aspects 20 through 30.

Aspect 48: A network entity for wireless communications, comprising one or more memories storing processor-executable code, and one or more processors coupled with the one or more memories and individually or collectively operable to execute the code to cause the network entity to perform a method of any of aspects 31 through 38.

Aspect 49: A network entity for wireless communications, comprising at least one means for performing a method of any of aspects 31 through 38.

Aspect 50: A non-transitory computer-readable medium storing code for wireless communications, the code comprising instructions executable by one or more processors to perform a method of any of aspects 31 through 38

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a request for a downlink control parameter associated with a control channel, wherein the downlink control parameter indicates one or more of: a precoder cycling or a demodulation reference signal (DMRS) bundling; and
receive, based at least in part on the request, a downlink control message in accordance with the downlink control parameter.

2. The UE of claim 1, wherein, to transmit the request, the one or more processors are individually or collectively operable to execute the code to cause the UE to:
transmit a control signal indicating the request, wherein the control signal indicates one or more of: a medium access control-control element (MAC-CE) or an uplink control channel message.

3. The UE of claim 1, wherein, to transmit the request, the one or more processors are individually or collectively operable to execute the code to cause the UE to:
transmit a scheduling request, wherein the scheduling request comprises the request for the downlink control parameter.

4. The UE of claim 1, wherein the one or more processors are individually or collectively further operable to execute the code to cause the UE to:
receive, based at least in part on the request, a confirmation associated with the request.

5. The UE of claim 1, wherein the downlink control parameter associated with the request is valid for a defined time duration.

6. The UE of claim 1, wherein the downlink control parameter associated with the request is valid until an indication of a change to the downlink control parameter is received.

7. The UE of claim 1, wherein, to transmit the request, the one or more processors are individually or collectively operable to execute the code to cause the UE to:
transmit the request based at least in part on a channel signal-to-noise ratio (SNR) estimate satisfying a defined threshold.

8. The UE of claim 7, wherein the one or more processors are individually or collectively further operable to execute the code to cause the UE to:
receive control signaling that indicates the defined threshold.

9. The UE of claim 1, wherein, to transmit the request, the one or more processors are individually or collectively operable to execute the code to cause the UE to:
transmit the request for the precoder cycling; and
receive, based at least in part on the request, control signaling indicating a configuration associated with a unitary rotation for the downlink control message, the configuration indicating one or more resources of the control channel associated with the downlink control message.

10. The UE of claim 9, wherein the unitary rotation comprises a two-symbol unitary rotation.

11. The UE of claim 10, wherein the two-symbol unitary rotation is applied to at least a quadrature phase shift keying (QPSK) symbol associated with the control channel.

12. A user equipment (UE), comprising:
one or more memories storing processor-executable code; and
one or more processors coupled with the one or more memories and individually or collectively operable to execute the code to cause the UE to:
receive first control signaling indicating a first configuration associated with a unitary rotation for a first downlink control message, wherein the first configuration indicates one or more first resources of a control channel associated with the first downlink control message and a precoder cycling; and
receive the first downlink control message via the one or more first resources of the control channel, the first downlink control message having the unitary rotation applied in accordance with the first configuration.

13. The UE of claim 12, wherein the unitary rotation comprises a two-symbol unitary rotation.

14. The UE of claim 13, wherein the two-symbol unitary rotation is applied to at least a quadrature phase shift keying (QPSK) symbol associated with the control channel.

15. The UE of claim 12, wherein the first configuration indicates an absence of demodulation reference signal (DMRS) bundling.

16. The UE of claim 12, wherein the first configuration indicates a distributed mapping of resource element group (REG) bundles to control channel elements (CCEs) or a non-distributed mapping of REG bundles to CCEs.

17. The UE of claim 12, wherein the one or more processors are individually or collectively further operable to execute the code to cause the UE to:
transmit a request for a demodulation reference signal (DMRS) bundling; and
receive, based at least in part on the request, a confirmation associated with the request.

18. The UE of claim 12, wherein the one or more processors are individually or collectively further operable to execute the code to cause the UE to:
transmit, subsequent to the first control signaling, a request for a demodulation reference signal (DMRS) bundling; and
receive, based at least in part on the request, a second downlink control message in accordance with the request, wherein the second downlink control message is exempt from the unitary rotation in accordance with the first configuration.

19. The UE of claim 12, wherein the one or more processors are individually or collectively further operable to execute the code to cause the UE to:
receive second control signaling indicating a second configuration unassociated with the unitary rotation, the second configuration indicating one or more second resources of the control channel associated with a second downlink control message; and
receive the second downlink control message via the one or more second resources of the control channel, the second downlink control message in accordance with the second configuration.

20. A network entity, comprising:
one or more memories storing processor-executable code; and
one or more processors coupled with the one or more memories and individually or collectively operable to execute the code to cause the network entity to:
obtain a request for a downlink control parameter associated with a control channel, wherein the downlink control parameter indicates one or more of: a precoder cycling or a demodulation reference signal (DMRS) bundling; and
output, based at least in part on the request, a downlink control message in accordance with the downlink control parameter.

21. The network entity of claim 20, wherein the one or more processors are individually or collectively further operable to execute the code to cause the network entity to:
output, based at least in part on the request, a confirmation associated with the request.

22. The network entity of claim 20, wherein, to obtain the request, the one or more processors are individually or collectively operable to execute the code to cause the network entity to:
obtain the request based at least in part on a channel signal-to-noise ratio (SNR) estimate satisfying a defined threshold.

23. The network entity of claim 22, wherein the one or more processors are individually or collectively further operable to execute the code to cause the network entity to:
output control signaling that indicates the defined threshold.

24. The network entity of claim 20, wherein, to obtain the request, the one or more processors are individually or collectively operable to execute the code to cause the network entity to:
obtain the request for the precoder cycling; and
output, based at least in part on the request, control signaling indicating a configuration associated with a unitary rotation for the downlink control message, the configuration indicating one or more resources of the control channel associated with the downlink control message.

25. A network entity, comprising:
one or more memories storing processor-executable code; and
one or more processors coupled with the one or more memories and individually or collectively operable to execute the code to cause the network entity to:
output first control signaling indicating a first configuration associated with a unitary rotation for a first downlink control message, wherein the first configuration indicates one or more first resources of a control channel associated with the first downlink control message and a precoder cycling; and
output the first downlink control message via the one or more first resources of the control channel, the first downlink control message having the unitary rotation applied in accordance with the first configuration.

26. The network entity of claim 25, wherein the unitary rotation comprises a two-symbol unitary rotation.

27. The network entity of claim 26, wherein the two-symbol unitary rotation is applied to at least a quadrature phase shift keying (QPSK) symbol associated with the control channel.

28. The network entity of claim 25, wherein the one or more processors are individually or collectively further operable to execute the code to cause the network entity to:
obtain a request for a demodulation reference signal (DMRS) bundling; and
output, based at least in part on the request, a confirmation associated with the request.

29. The network entity of claim 25, wherein the one or more processors are individually or collectively further operable to execute the code to cause the network entity to:
obtain, subsequent to the first control signaling, a request for a demodulation reference signal (DMRS) bundling; and
output, based at least in part on the request, a second downlink control message in accordance with the request, wherein the second downlink control message is exempt from the unitary rotation in accordance with the first configuration.

30. The network entity of claim 25, wherein the one or more processors are individually or collectively further operable to execute the code to cause the network entity to:
output second control signaling indicating a second configuration unassociated with the unitary rotation, the second configuration indicating one or more second resources of the control channel associated with a second downlink control message; and
output the second downlink control message via the one or more second resources of the control channel, the second downlink control message in accordance with the second configuration.
